(19) United States
(12) Patent Application Publication
(10) Pub. No.: US 2008/0126649 A1
(43) Pub. Date: May 29, 2008

(54) Low latency mechanism for asynchronously running a code segment on a processor in a remote computer by transmitting a special network packet or datalink frame that causes a hardware interrupt

(76) Inventor: George Madathilparambil George, Bangalore (IN)

Correspondence Address: GEORGE MADAT-H-ILPARAMBIL GEORGE, 307, VAYU, MY HOME NAVADWEEPA, MADHAPUR, HYDERABAD, 500081, omitted

(21) Appl. No.: 11/520,966

(22) Filed: Sep. 15, 2006

(51) Int. Cl. G06F 13/24; G06F 9/44

(52) U.S. Cl. 710/260; 719/330

(57) ABSTRACT

We are proposing a low latency mechanism for asynchronously running a code segment on a processor in a remote computer by transmitting a special network packet or datalink frame that causes a hardware interrupt. Preferably, the mechanism for invoking the interrupt uses MSI or MSI-X. The information required for interrupting a processor in a remote system is sent in a special network packet or datalink frame.

### BACKGROUND OF THE INVENTION

Existing mechanisms for executing code segments on remote processors are not efficient for highly latency sensitive applications. Existing mechanisms for invoking a code on remote systems involve sending a message to a remote server application, which in turn invokes the desired code.

Existing mechanisms are inefficient for highly latency sensitive applications such as code segments or programs that should get invoked during emergencies such as a computer virus attack, an incoming missile, etc. where even a delay of microseconds can result in a disaster. Today many mission critical applications require special ASICs (Application Specific Integrated Circuits) to handle latency requirements.

It is desirable to have a low latency mechanism for execution of code on a remote system for latency sensitive distributed applications which invoke a code segment on a remote systems.

It is also important that latency sensitive networking applications process incoming RDMA read or write completions quickly. If a latency sensitive application can invoke a code in a remote system processor while sending latency sensitive data or completions, it can improve response times.

### BRIEF SUMMARY OF THE INVENTION

The present invention relates to a method of asynchronously interrupting a remote system processor and invoking a code segment in the remote system directly or indirectly.

The parameter definitions and parameter values required for interrupting a remote processor and invoking a code segment is passed to a remote application using one or more network packets. A parameter definition will define the type of the parameter, for example a function pointer or a variable to be passed to a function. The parameter value will contain the actual function pointer or value for the variable etc. We refer to the parameter definition and parameter value pair as a Parameter. If the parameter definition is implicit, the Parameter may optionally contain only parameter value.

The remote application uses the Parameters to create a special network packet or datalink frame and transmits the packet/frame to a switch or a Network Interface Card in another system. The special network packet or datalink frame contains Parameters for invoking an interrupt in the remote system that receives the packet or datalink frame. The Parameters for invoking an interrupt preferably contain an MSI/MSI-X vector and MSI/MSI-X datum. The special packet or datalink frame is referred to as “Code Segment Invoking Network Packet or Datalink Frame” or CSINPDF.

The interrupt service routine (ISR) that processes that CSINPDF uses the Parameters contained in the CSINPDF to invoke one or more code segments directly or indirectly.

The direct invocation of a code segment may be by invoking the code or calling a function specified in one or more Parameters. The control goes back to the ISR after the code segment is executed. The code segment or the function called by an ISR is should not block and must be resident in memory.

Indirect invocation of a code segment may be done by doing a wakeup of a thread using a value or address specified in a Parameter; Another way of indirect invocation of a code segment is by causing an event specified in a Parameter. The indirect invocation uses interfaces provided by operating systems. The interfaces used by an ISR for indirect invocation of code segment should not block.

Some of the Parameters in the CSINPDF could be used by the code that is invoked. Based on the parameter definition in the Parameter, such parameter values may be pushed to the stack, or stored in an absolute or relative address or in a location specified in the parameter definition.

### BRIEF DESCRIPTION OF THE SEVERAL VIEWS OF THE DRAWINGS

FIG. 1 illustrates an example of a state machine of a Network Interface Card which processes the incoming CSINPDFs and generates an interrupt.

FIG. 2A illustrates an example for transmission of a network packet which is used for sending Parameters to be used for invoking a code segment in a computer by a remote application.

FIG. 2B illustrates transmission of a CSINPDF from an application to a network interface card (NIC) which can handle CSINPDF.

FIG. 3A illustrates an example of a CSINPDF containing 3 Parameters.

FIG. 3B illustrates an examples of the contents of the Parameters.

### DETAILED DESCRIPTION OF THE INVENTION

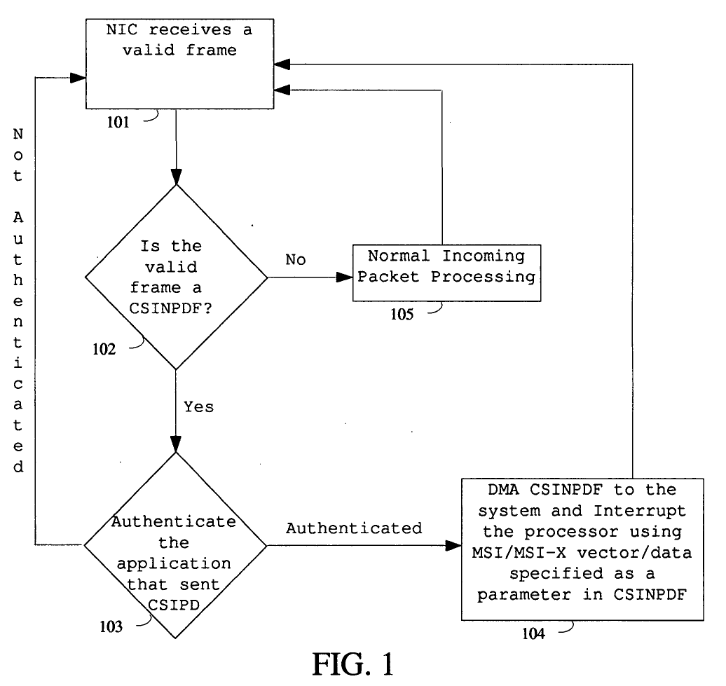

FIG. 1 illustrates an example for a state machine of a Network Interface Card (NIC) that can process the CSINPDF. Only the receive side of the state machine is shown as the transmit side is not impacted by the CSINPDF. When a new valid datalink frame (a valid datalink frame is a datalink frame with a valid checksum or CRC etc.) is received 101, the NIC checks whether the frame format corresponds to CSINPDF 102. If the frame format does not corresponds to CSINPDF 105, the frame is treated as a normal datalink frame. If a CSINPDF is received 103, the application that sent the CSINPDF is authenticated 103. If authentication fails, the CSINPDF is discarded. If authentication is successful 104, the CSINPDF is DMAed into the computer memory 104 and the MSI/MSI-X vector and data specified in a CSINPDF Parameter (not shown) is used to interrupt 104 a CPU on the computer. The interrupt causes an ISR (not shown) to be invoked which processes the CSINPDF and Parameters contained in the CSINPDF. The ISR directly or indirectly invokes code segments requested in the Parameters in the CSINPDF.

The format of the CSINPDF is implementation specific and must be different from the format of other supported datalink frames and network packets. The format of the CSINPDF should be easily identifiable by a NIC or switch. For example, the first data byte in an Ethernet packet (after length field) or the Ethernet packet source address, etc. could be used to differentiate a CSINPDF from other datalink frames or network packets.

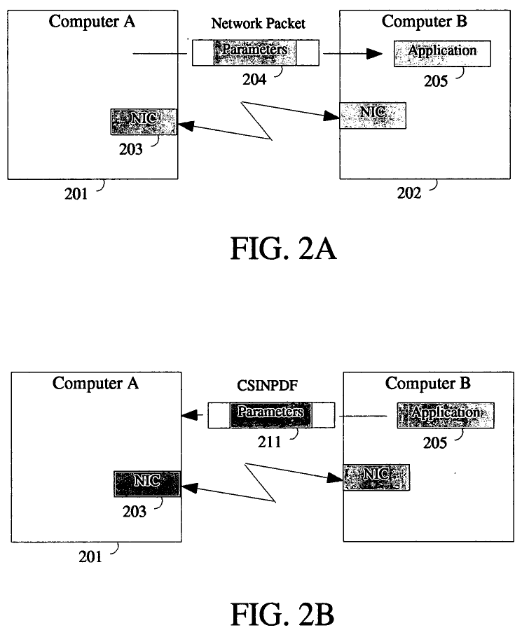

FIG. 2A illustrates an example of how the Parameters required for creating a CSINPDF is transmitted to a remote application. The Computer A 201 and the computer B 202 are connected through a network. The network interface card (NIC) 203 connecting Computer A to the network is capable of handling CSINPDFs. An application (not shown) in Computer A establishes a connection with an application 205 which runs on Computer B and is capable of generating CSINPDFS. The connection is used for sending 204 Parameters to the application 205.

The Parameters can be sent to different applications on different computers.

In FIG. 2B illustrates an example of how a code segment can be invoked on a remote computer. When execution of the application 205 running on the Computer B requires invoking a particular code segment on the Computer A 201, the application can send a CSINPDF to invoke that code segment, provided the required Parameters are available with the application 205. The application 205 invokes a code segment on the Computer A by sending a CSINPDF 211 to the NIC 203 on Computer A.

The code invoked on a remote computer may be a function or a code segment. A code segment or a function directly invoked by an ISR must be resident in the computer memory. If the code segment or the function called by the ISR is not resident, the call to the code segment or the function will block and ISR is not allowed to block. Preferably, such code and functions must be part of the operating system kernel.

If the code invoked is a function, the caller must setup arguments and return pointers for the function to return to the caller.

The code segment invoked indirectly may be a kernel or a user space thread. The thread may be invoked by performing a wakeup on an address in a Parameter or on an address derived from a Parameter, where the Parameter is sent in a CSINPDF. A thread may be invoked by making an event occur. The method used for invoking a thread indirectly is operating system and implementation specific.

Some Parameters in a CSINPDF may be created by the application creating the CSINPDF.

Preferably, the Parameters required for interrupting a remote processor is an MSI/MSI-X vector and data, or an index, or an identifier. If an index or identifier is used, the NIC processing the CSINPDF must be capable of deriving MSI/MSI-X vectors and data using the index or the identifier.

A NIC or a switch processing CSINPDFs must be capable of generating a hardware interrupt to the computer to which it is connected or attached.

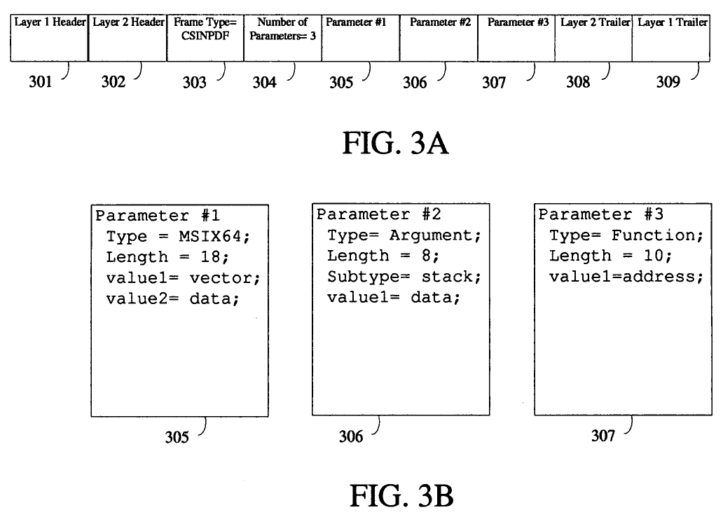

FIG. 3A illustrates an example for the format of a CSINPDF. The frame contains layer 1 header 301, layer 2 header 302, layer 2 trailer 308 and layer 1 trailer 309. The first field after the headers 303 identify the frame as a CSINPDF. The next field 304 gives the number of parameters in the CSINPDF. There are three Parameters 305 306 307.

FIG. 3B illustrates an example for the contents of Parameters. The first parameter 305 is an MSI-X vector and supports a 64 bit address. The length of the Parameter #1 is 18 bytes and contains an MSI-X vector and data. This parameter is used by a NIC or switch to generate an interrupt. The Parameter #2 306 is an argument to be used with a function call. The length of the Parameter #2 is 8 bytes. The argument is to be pushed to the stack as an argument for a function call specified in the next parameter. The Parameter #3 307 is an address to a function to be invoked. The length of the Parameter #3 is 10 bytes. The Parameter #3 contains the address of the function to be used for making a function call by an ISR.

Preferably, a CSINPDF contains a sequence number and an ISR can reject duplicate CSINPDFs. This will enable the retransmission of CSINPDFs.

Optionally, a frame containing a CSINPDF may also contain data; The data contained in a CSINPDF frame may be an RDMA packet; The NIC in this case should be capable of doing DMA for the data part and another DMA for the CSINPDF. This will allow consumption of an RDMA packet as soon as it arrives.

What is claimed is:

1. A method for executing a code segment on a processor in a remote system by:
i) Sending a set of parameter definitions and parameter values using normal network packets to one or more remote applications or remote softwares; A parameter definition will define the type of the parameter, for example a function pointer, or a variable to be passed to a function, etc. The parameter value will contain the actual function pointer, or value for the variable, etc. We refer to the parameter definition and parameter value pair as a Parameter. If the parameter definition is implicit, the Parameter may optionally contain only the parameter value.
ii) One of the Parameters sent to a remote application or a remote software containing the parameter definitions and parameter values required to invoke a hardware interrupt on another computer;
iii) If a remote application or a remote software that received these Parameters, needs to invoke a code segment on the the computer for which the Parameters are received, the remote application/s or remote software/s sending a datalink frame or a network packet of a special format to a Network Interface Card or a Switch attached to the computer, to invoke the code segment.
iv) The datalink frame or network packet of a special format which is used to invoke a hardware interrupt and a code segment on a remote computer is called “Code Segment Invoking Network Packet or Datalink Frame” or CSINPDF;
v) Preferably, when a CSINPDF is received, the destination NIC or the destination switch authenticating the application that sent the CSINPDF;
vi) The destination NIC or the destination switch generating a hardware interrupt on the host computer to which it is attached, after a CSINPDF or preferably, an authenticated CSINPDF is received;
vii) Preferably, the interrupt is generated on a remote computer by sending one or more Parameters containing an MSI or MSI-X vector and data or an index/identifier which can be used to identify an MSI/MSI-X vector and data, in a CSINPDF;
viii) Preferably, the interrupt service routine (ISR) which processes the interrupt caused by a CSINPDF, validating the Parameters contained in the CSINPDF;
ix) Preferably, a CSINPDF containing one or more Parameters;
x) Preferably, the ISR processing the interrupt caused by a CSINPDF, processes the Parameters in the CSINPDF and invokes the code segments requested by the Parameters;
xi) The invocation of a code segment may be done by the ISR calling the code segments directly or indirectly.
xii) Some of the parameters in a CSINPDF may be used as arguments for the code segment that is invoked.

2. As claimed in (1), the Parameters for invoking a code segment on a computer, may be sent to one or more applications or softwares running on one or more remote computers.

3. As claimed in (1), Parameters could be sent to remote applications or remote softwares using connection oriented or connectionless communication.

4. As claimed in (1), CSINPDFs are sent to a NIC attached to a computer where the NIC is capable of invoking a hardware interrupt on the computer and is capable of processing the CSINPDFs.

5. As claimed in (1), CSINPDFs are sent to a network switch attached to a computer where the network switch is capable of invoking a hardware interrupt on the computer and the NIC is capable of processing the CSINPDFs.

6. As claimed in (1), a CSINPDF contains one or more Parameters.

7. Optionally, as claimed in (6), CSINPDF contains no other Parameters other than Parameters required for invoking a hardware interrupt of claim (1).

8. As claimed in (1), an ISR processes Parameters in CSINPDFs. The Parameters are of different types and the ISR takes appropriate action for each type of Parameter as follows:
i) If a Parameter is for direct invocation and contains a computer code address as a parameter value or a parameter value to be used for deriving the address, the code segment is called by the ISR; A code segment directly invoked by an ISR must be resident in the computer memory and must return control to ISR after the code execution.
ii) If a Parameter is for direct invocation by the ISR and contains a function identifier such as a function address or a function name, the function is called by the ISR after a stack and arguments are setup for the function by the ISR; A function directly invoked by an ISR must be resident in the computer memory.
iii) If a Parameter is for indirect invocation and contains a wakeup address for a kernel/user thread, a wakeup is performed on the thread by using an operating system wakeup interface;
iv) If a Parameter is for indirect invocation and contains an event identifier, the ISR performs the event;
v) If a Parameter contains arguments for the code being. invoked and the Parameter contains a stack variable, the arguments are pushed to the stack setup by the ISR before calling the function;
vi) If a Parameter contains arguments for the code being invoked and the Parameter contains a value for a global variable, the value of the global variable is updated.

9. The parameter as claimed in (1), could be used for sending a UNIX signal to a UNIX process and other nonblocking operations that can be performed by an ISR.

10. A code segment or a function invoked directly by an ISR as claimed in (1) must not block.

11. Some Parameters in a CSINPDF of claim (1) may be created by the application creating the CSINPDF.

12. Preferably, a CSINPDF of claim (1) contains a sequence number which can be used by the ISR processing CSINPDFs for discarding duplicate CSINPDFs having same sequence numbers.

13. Optionally, a frame of containing a CSINPDF may also contain data; The data contained in the CSINPDF may be an RDMA packet;
